(19) United States
(12) Patent Application Publication
(10) Pub. No.: US 2013/0288670 A1
(43) Pub. Date: Oct. 31, 2013

(54) SIGNALING OF PREFERRED VISITED NSP FOR ROAMING SERVICES

(71) Applicants: Danny Moses, Reut (IL); Avishay Sharaga, Bet Nehemya (IL)

(72) Inventors: Danny Moses, Reut (IL); Avishay Sharaga, Bet Nehemya (IL)

(21) Appl. No.: 13/995,054

(22) PCT Filed: Sep. 6, 2011
(86) PCT No.: PCT/US11/50521

§ 371 Date: Jun. 17, 2013

(51) Int. Cl. H04W 48/18

(52) U.S. Cl. CPC H04W 48/18
USPC 455/432.1

(57) ABSTRACT

A wireless communication receives a message from a Home Network (HN) of the device containing information relating to one or more preferred Visited Networks (VNs) for a wireless roaming service connection, and determines a Visited Network (VN) from the information relating to one or more preferred VNs for a wireless roaming service connection. The one or more preferred VNs are preferred based on a geographic location of the device. Exemplary embodiments of the wireless communication device include a notebook-type computer, a tablet-type computer device, a portable or a handheld communication-type device, a reader-type device, a cellular telephone, or a personal digital assistant.

### BACKGROUND

The present patent application relates to wireless communications. More particularly, the present patent application relates to connection techniques for roaming wireless device (WD) in which a Home Network (HN) of the WD provides real-time roaming network selection information to the WD.

When roaming, a wireless device (WD), such as a Mobile Station (MS), is located in an area that is not covered by the Home Network (HN) of the WD. Accordingly, the WD connects through a physically local wireless network in order to connect to the HN. The physically local wireless network through which the WD connects to the HN has been referred to in the literature by various names. As used herein, the physically local wireless network through which a WD connects to the HN of the wireless device will be referred to as a “Visited Network” or “VN.”

When a WD scans, but does not find its HN, the WD enters a roaming scenario. While scanning for a candidate connection during roaming, a WD may detect several candidates for a VN. Conventionally, the WD selects one of the candidate VNs based on specific operative criteria programmed into the WD. There may be different operative criteria for selecting a VN depending on the situation, such as whether the VN is a roaming-service partner for the HN of the WD; the signal quality between the WD and a VN; the time taken for the WD to detect candidate VNs; and/or a cost for the roaming service, which may vary depending on the particular VN. At the time the WD is configured for a service from a particular HN, the WD can be programmed with a prioritized list of preferred partner operators with the expectation that the WD will automatically select a preferred partner operator during a roaming connection. This conventional technique has the limitation of not being scalable and is inefficient when there are a large number of networks and complex direct (or indirect) business relationships between the available networks and the HN. Another drawback includes the priority of preference of a particular partner operator may change from one geographic region to another, thereby causing the selection process to be less than optimal. Yet another drawback is that when a WD conventionally selects a VN, the HN of the WD has no ability to influence the selection made by the WD at the time the WD connects to the VN. Further, when a user of a WD manually selects a VN, there is a possibility that the selected VN is not a preferred VN of the HN.

Additionally, a number of wireless communication standards provide well-known techniques for configuring a WD while the WD is connected to a wireless communication network. Known examples are the OMA-DM protocol, TR-069 and the 3GPP-defined OTA (based on SMS) protocols. Although these conventional techniques have various advantages, they are not optimal for interactively communicating information relating to a preferred VN to a roaming WD because these conventional techniques require full and complete connection to the HN prior to being able to begin communicating the preferred. VN information. Accordingly, these conventional techniques require that a WD disconnect from the VN initially connected to after being configured, and then reconnect to a preferred VN, thereby likely resulting in a bad subscriber experience because of the connect/disconnect/reconnect network behavior. These known protocols also rely on client software that must be loaded and configured in a WD during the roaming connection, and the operations may take several seconds to be completed. Further still, the network infrastructure supporting these protocols is expensive and is tuned for rare usage, such as, after a network upgrade, or when a user initiates a service subscription. That is, these protocols are not tuned for usage whenever a roaming session takes place.

### DESCRIPTION OF THE DRAWING FIGURES

Claimed subject matter is particularly pointed out and distinctly claimed in the concluding portion of the specification. Such subject matter may, however, be understood by reference to the following detailed description when read with the accompanying drawings in which:

FIG. 1 depicts a block diagram of a wireless network in accordance with one or more exemplary embodiments of the subject matter disclosed herein;

FIG. 2 depicts an exemplary flow diagram for a process of connecting a roaming wireless device to an arbitrary Visited Network according to the subject matter disclosed herein;

FIG. 3 depicts an exemplary signal flow diagram for a roaming wireless device connecting to an arbitrary Visited Network in which the wireless device selects a preferred Visited Network recommended by the Home Network; and

FIG. 4 depicts an exemplary signal flow diagram of a roaming wireless device connecting to an arbitrary Visited Network in which the wireless device selects a Visited Network different from a preferred Visited Network recommended by the Home Network.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. It will, however, be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. Coupled may, however, also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. “Over” may, however, also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other. As used herein, the word “exemplary” means “serving as an example, instance, or illustration.” Any embodiment described herein as “exemplary” is not to be construed as necessarily preferred or advantageous over other embodiments.

The subject matter disclosed herein relates to a flexible and dynamic technique for a Home Network (HN) to transparently (from the perspective of a user) specify or to suggest to a wireless device (WD), such as a Mobile Station (MS), a preferred Visited Network (VN) taking into account the current physical location of the WD. Additionally, the subject matter disclosed herein relates to a technique for a roaming WD to transparently (from the perspective of a user) receive information about one or more preferred roaming-service partners from the HN of the WD when the WD connects to an arbitrary VN during a roaming-service network connection.

When a WD is located in an area that is not covered by the HN of the WD, the WD connects to the HN through a roaming-service process to a physically local VN. The preference by the HN for one or more specific VNs may be based on various considerations (other than purely based on cost to the subscriber), such as a business relationship between the HN service provider and another service provider in a particular geographic location.

During the initial stages of a WD connecting to a wireless network, the WD and the authentication server of the HN mutually authenticate each other. The authentication process is performed between the WD and the HN through an indirect, logical peer-to-peer connection between the two peers. Physically, the WD and the HN are connected through one or more servers that forward the traffic between the WD and HN authentication server. The subject matter disclosed herein utilizes a direct peer-to-peer connection to the HN for the HN to communicate to the WD information relating to one or more preferred VNs if the VN through which the WD has originally connected is different form the one or more HN-preferred VNs.

For WiMAX-based networks, authentication is conventionally performed using the Extensible Authentication Protocol (EAP), which includes an EAP-notification message received by a WD (if sent) from the HN that includes text that is displayed to a user (subscriber). According to the subject matter disclose herein, additional information is included as part of a modified EAP-notification-type message that provides information relating to one or more preferred VNs in the text field of the message. The additional information is identified by the WD, for example, by special characters encapsulating the additional information. The additional information is separated from the text that is displayed to a user before the displayable text is displayed.

After receiving the message containing the information relating to the one or more preferred VNs, the WD can reinitiate (transparently from the perspective of the user) the network entry process using the indicated preferred VN, or alternatively can ignore the preferred VN information and continue network entry with the initially selected VN based on, for example, device configuration and/or user-preference.

The subject matter disclosed herein provides an advantage of being real time and is independent of device configuration; consequently, all WD devices associated with a HN are not required to be updated for every change in a preferred VN list. Updates are provided only when a WD connects to a VN for roaming service. A HN has the capability to determine the geographic location of a WD before sending a message containing information relating to the one or preferred VNs for the geographic location. In one exemplary embodiment, the HN authentication server receives the identity of the VN via the EAP signaling. Using this identity, the HN authentication server can interact with the VN in a well-known manner to obtain information including geographical location of the WD (or rather, the identity of the base-station that serves it). Moreover, the information relating to the one or more preferred VNs needs only a minimal mount of communication link overhead. Further, the process is transparent to a subscriber who will not be aware of the VN selection process.

The subject matter disclosed herein provides two modes of operation: either the WD is configured to follow the preference of the HN, or the WD can be configured to use the preference of the HN as a recommendation. The subject matter disclosed herein is backwards compatible with the current implementation. That is, if a HN does not support signaling to a WD information relating to one or more preferred VNs, the HN does not signal a preference. If the WD does not support receiving information relating to one or more preferred VNs, the WD will ignore the preferred VN information signal. The two modes also provide flexibility for a subscriber that has a reason to disable automatic selection of VN and manually select a VN preference based on, for example, price differences, radio signal strength, etc.

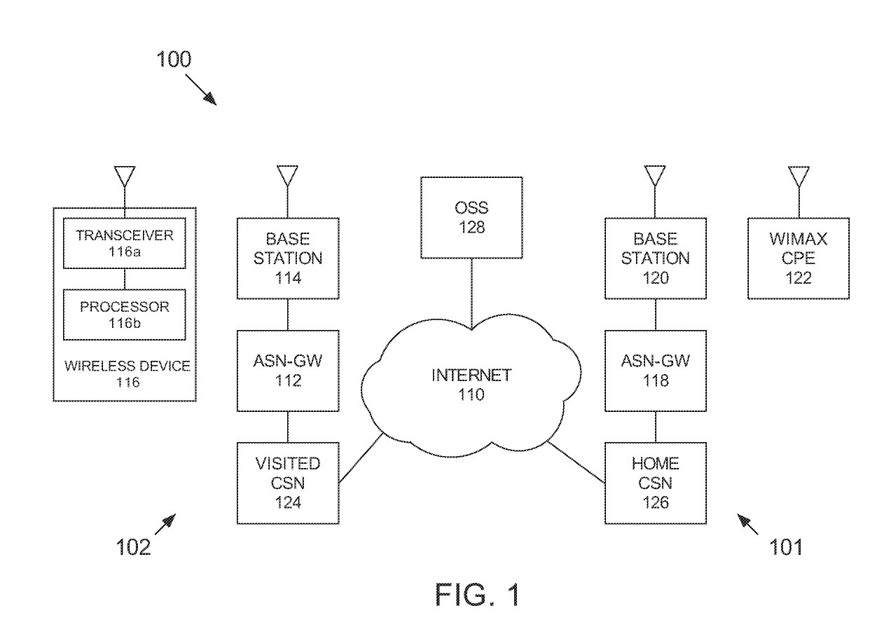

FIG. 1 depicts a block diagram of a wireless network in accordance with one or more exemplary embodiments will be discussed. As shown in FIG. 1, network 100 may be an Internet-Protocol-type (IP-type) network comprising an Internet-type network 110, or the like, that is capable of supporting mobile wireless access and/or fixed wireless access to Internet 110 or another telecommunications network. In one or more exemplary embodiments, network 100 may be in compliance with a Worldwide Interoperability for Microwave Access (WiMAX) standard or future generations of WiMAX, and in one particular embodiment may be in compliance with an Institute for Electrical and Electronics Engineers standard (for example, IEEE 802.16). In one or more exemplary alternative embodiments network 100 may be in compliance with a Third Generation Partnership Project Long Term Evolution (3GPP LIE) or a 3GPP2 Air Interface Evolution (3GPP2 AIE) standard. In general, network 100 may comprise any type of orthogonal frequency-division multiplexing (OFDM) type wireless network, and/or any type of code division multiple access (CDMA) based wireless network, and the scope of the claimed subject matter is not limited in this regard.

As an example of mobile wireless access, an access service network (ASN) comprising an access service network Gateway (ASN-GW) 112 and one or more Base Stations (BS) 114, and a visited core service network (CSN) 124 are capable of coupling to provide wireless communication between a wireless device (WD) 116, such as a Mobile Station (MS), and Internet 110 and/or between WD 116 and Home Network (HN) 101. WD 116 may comprise a mobile-type device or information-handling system capable of wirelessly communicating via network 100, such as, a notebook-type computer, a tablet-type computer device, a portable or a handheld communication-type device, a reader-type device, a cellular telephone, a personal digital assistant, or the like. WD 116 also comprises a transceiver portion 116a and a processor portion 116b that are operative coupled together in a well-known manner. It should be understood that WD 116 may comprise other components that are not depicted, but are well-known to comprise mobile stations. ASN-GW 112 may implement profiles that are capable of defining the mapping of network functions to one or more physical entities on network 100. Base station 114 may comprise radio equipment to provide radio-frequency (RF) communication with subscriber station 116, and may comprise, for example, the physical layer (PITY) and media access control (MAC) layer equipment in compliance with an IEEE 802.16e type standard. Base station 114 may further comprise an IP backplane to couple to Internet 110 via ASN-GW 112, although the scope of the claimed subject matter is not limited in these respects.

Network 100 may further comprise a visited connectivity service network (CSN) 124 that is part of a Visited Network (VN) 102. CSN 124 is capable of providing one or more network functions including, but not limited to, proxy and/or relay type functions, for example, authentication, authorization and accounting (AAA) functions, dynamic host configuration protocol (DHCP) functions, or domain name service controls or the like, domain gateways, such as public switched telephone network (PSTN) gateways or Voice over Internet Protocol (VoIP) gateways, and/or Internet-Protocol-type (IP-type) server functions, or the like. These are, however, merely example of the types of functions that are capable of being provided by visited CSN or home CSN 126, and the scope of the claimed subject matter is not limited in these respects. Visited CSN 124 may be referred to as a visited CSN in the case for example in which visited CSN 124 is not part of the regular service provider of subscriber station 116, for example, in which WD 116 is roaming away from its home CSN, such as home CSN 126, or for example, in which network 100 is part of the regular service (HN) provider of WD 116, but in which network 100 may be in another location or state that is not the main or home location of WD 116. In a fixed wireless arrangement, WiMAX type customer premises equipment (CPE) 122 may be located in a home or business to provide home or business customer broadband access to Internet 110 via base station 120, ASN-GW 118, and home CSN 126 in a manner similar to access by WD 116 via base station 114, ASN-GW 112, and visited CSN 124, a difference being that WiMAX CPE 122 is generally disposed in a stationary location, although it may be moved to different locations as needed, whereas WD may be utilized at one or more locations if WD 116 is within range of base station 114, for example, in accordance with one or more embodiments, operation support system (OSS) 128 may be part of network 100 to provide management functions fir network 100 and to provide interfaces between functional entities of network 100. Network 100 of FIG. 1 is merely one exemplary type of wireless network showing a certain number of the components of network 100, however, the scope of the claimed subject matter is not limited in these respects.

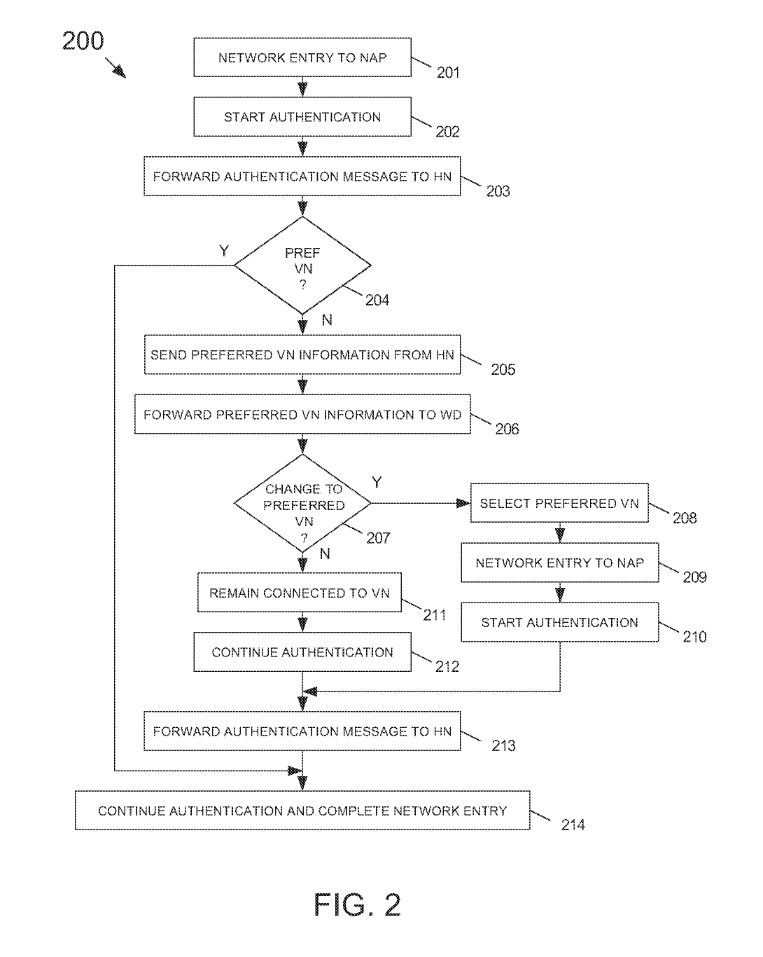

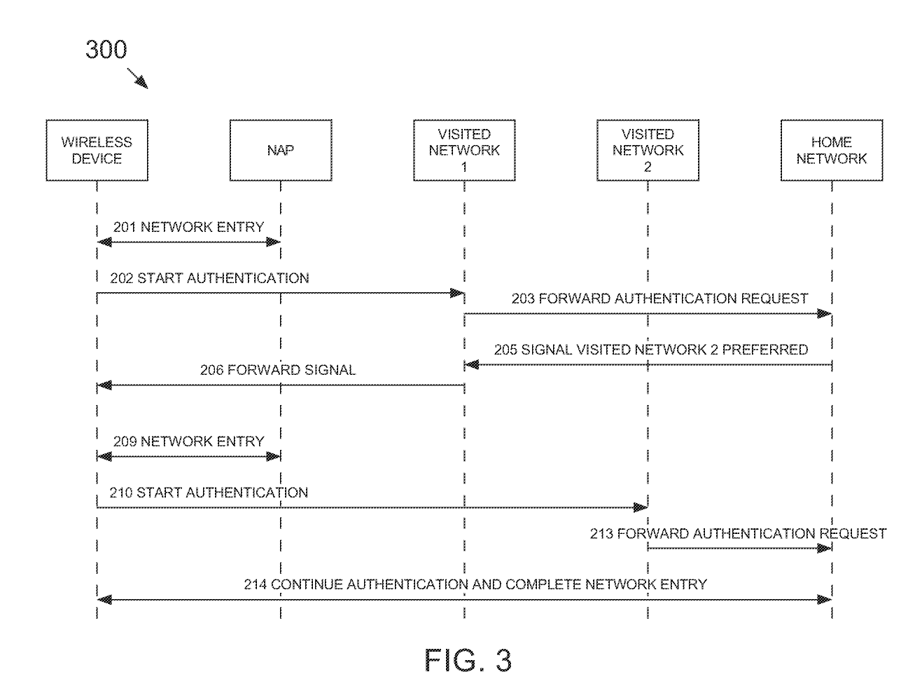

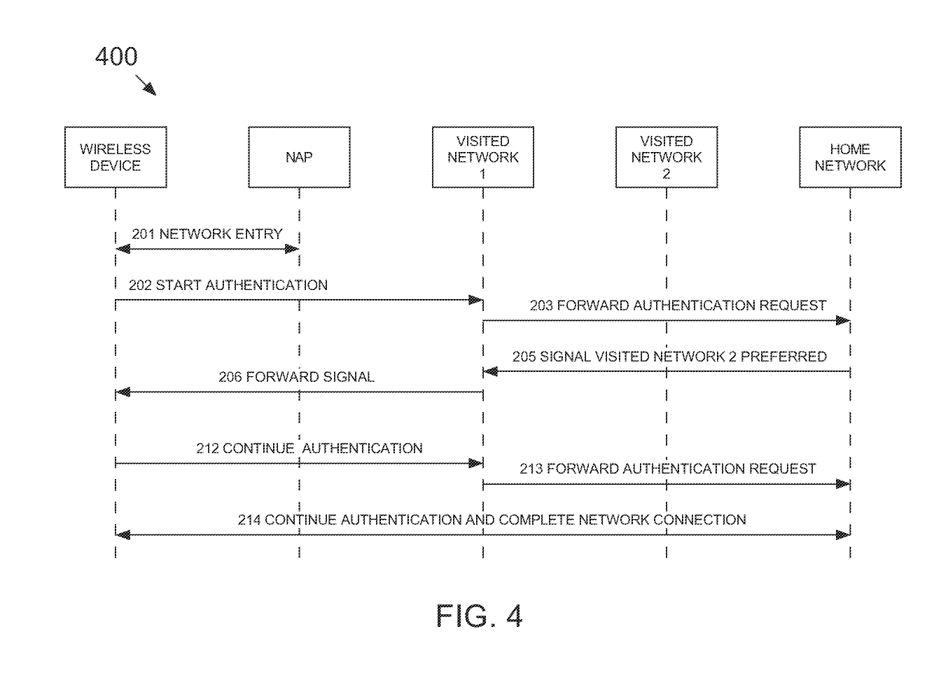

FIG. 2 depicts an exemplary flow diagram 200 for a process of connecting a roaming wireless device (WD), such as a Mobile Station (MS), to an arbitrary Visited Network (VN) according to the subject matter disclosed herein. FIG. 3 depicts an exemplary signal flow diagram 300 for a roaming WD connecting to an arbitrary VN in which the WD selects a preferred VN recommended by the HN. FIG. 4 depicts an exemplary signal flow diagram 400 of a roaming WD connecting to an arbitrary VN in which the WD selects a VN different from a preferred VN recommended by the HN. FIGS. 3 and 4 include reference numerals corresponding to particular blocks in FIG. 2.

In FIG. 2, the process begins at block 201 in which a roaming WD, such as WD 116 in FIG. 1, initiates wireless network entry in a well-known manner by transmitting a network-access-request-type message from transceiver portion 116a of WD 116 to, for example, a BS 114 which is part of an ASN that belongs to a Network Access Provider (NAP) that provides wireless connectivity services to Visited Network 1 (VN1). For purposes of illustration, VN 1 is an exemplary arbitrary VN that is available at the geographical location of the roaming WD. Flow continues to block 202 where the WD starts the authentication process by sending through, for example, Visited Network 1 VN (VN 1) an authentication request message to an authentication server of the HN. In one exemplary embodiment, the authentication request message is based on the Extensible Authentication Protocol (EAP). In alternative exemplary embodiment, the authentication request message is based on another authentication protocol. In yet another exemplary embodiment, the information relating to one or more preferred VNs can be communicated in a message protocol other than an authentication protocol. At block 203, VN 1 forwards the authentication request message received from the WD to the HN.

Flow continues to block 204, where the HN determines whether VN 1 is a preferred VN. If VN 1 is a preferred VN, flow continues to block 214, where the HN does not send to the WD a message that provides information relating to one or more preferred VNs, but instead continues authentication and completes connection of the WD to the HN. If, at block 204, the HN determines that VN 1 is not a preferred VN and that, for example, Visited Network 2 (VN 2) is a preferred VN, flow the continues to block 205 where the HN sends to the WD through VN 1 a message, such as a modified EAP-notification message, that provides information relating to one or more preferred VNs. In alternative exemplary embodiment, the message sent from the HN to the WD through VN 1 providing information relating to one or more preferred VNs could be based on another authentication protocol. Flow continues to block 206, where VN 1 forwards the message received from the HN to the WD, and the transceiver portion of the WD receives the forwarded message.

Flow continues to block 207, where the processor portion (i.e., processor portion 116b in FIG. 1) of the WD processes the received message by determining whether the WD was initially connected to a VN that is a preferred VN recommended by the HN. If, at block 207, the WD is not initially connected to a preferred VN recommended by the HN and the WD determines that it will connect to a preferred VN (regardless whether the WD can ignore the recommendation of the HN), flow continues to block 208 where the WD “selects” a preferred VN of the HN that is different from the VN to which the WD was initially connected. Flow continues to block 209 where the WD reinitiates wireless network entry at an ASN of a Network Access Provider (NAP). Flow continues to block 210 where the WD restarts the authentication process by sending through (preferred) VN 2 an authentication request message to an authentication server of the UN. In one exemplary embodiment, the authentication request message is based on the Extensible Authentication Protocol (EAP). In alternative exemplary embodiment, the authentication request message is based on another authentication protocol. Flow continues to block 213, where VN 2 forwards the authentication request message received from the WD to the HN. At block 214, the authentication continues and network entry is completed.

If, at block 207, the WD was initially connected to a VN that is a one of the preferred VNs recommended by the HN or determines that it will remain connected to the original VN and ignore the reconnection received from the HN, flow continues to block 211 where the WD remains connected to the VN. Flow continues to block 212, where the authentication process of the WD to the HN continues. Flow continues to block 213, where VN 2 forwards the authentication request message received from the WD to the HN. At block 214, the authentication continues and connection of the WD to the HN is completed.

It should be understood that while flow diagram 200 in FIG. 2 includes a decision block 207, in another exemplary embodiment in which the WD does not have the capability to ignore the preferred VN recommended by the UN, decision block 207 and blocks 211 and 212 would not be available to the WD.

Although the claimed subject matter has been described with a certain degree of particularity, it should be recognized that elements thereof may be altered by persons skilled in the art without departing from the spirit and/or scope of claimed subject matter. The claimed subject matter will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A device, comprising:
a transceiver to receive a message containing information relating to one or more preferred Visited Networks (VNs) for a wireless roaming service connection the one or more preferred VNs being preferred by a Home Network (HN) of the device; and
a processor coupled to the transceiver to determine a Visited Network (VN) from the information relating to one or more preferred VNs for a wireless roaming service connection.

2. The device according to claim 1, wherein the one or more preferred VNs are preferred based on a geographic location of the device when the transceiver receives the message.

3. The device according to claim 1, wherein the processor further to present to a user of the device a list of the one or more VNs for the wireless roaming service connection, the list containing the one or more preferred VNs contained in the information received in the message.

4. The device according to claim 3, wherein the processor further to determine a selection of a VN made by the user of the device from the list of the one or more VNs for the wireless roaming service connection, and
wherein the transceiver is responsive to the selection determined by the processor to make a wireless roaming service connection to the selected VN.

5. The device according to claim 4, wherein the device comprises a notebook-type computer, a tablet-type computer device, a portable or a handheld communication-type device, a reader-type device, a cellular telephone, or a personal digital assistant.

6. The device according to claim 1, wherein the one or more preferred VNs are based on a geographic location of the device.

7. The device according to claim 6, wherein the message is received from the Home Network (HN) of the device.

8. The device according to claim 7, wherein the one or more preferred VNs are preferred based on a geographic location of the device.

9. The device according to claim 7, wherein the message is received from the HN over a connection between the device and the HN.

10. The device according to claim 9, wherein the message received from the HN is based on an authentication protocol message.

11. The device according to claim 10, wherein the message received from the HN is based on an Extensible Authentication Protocol (EAP) message.

12. The device according to claim 6, wherein the received message containing information relating to one or more preferred VN is sent by the HN of the device in response to an authentication request sent from the device to the HN during a wireless roaming service connection.

13. The device according to claim 12, wherein the processor further to present to a user of the device a list of the one or more VNs for the wireless roaming service connection, the list containing the one or more preferred VNs contained in the information received in the message.

14. The device according to claim 13, wherein the processor further to determine a selection of a VN made by the user of the device from the list of the one or more VNs for the wireless roaming service connection, and
wherein the transceiver is responsive to the selection determined by the processor to make a wireless roaming service connection to the selected VN.

15. The device according to claim 12, wherein the device comprises a notebook-type computer, a tablet-type computer device, a portable or a handheld communication-type device, a reader-type device, a cellular telephone, or a personal digital assistant.

16. A system, comprising:
a Home Network (HN) responsive to an authentication request message received from a wireless communication device associated with the HN during a wireless roaming service connection of the device to send a message to the wireless communication device containing information relating to one or more preferred Visited Networks (VNs) for a wireless roaming service connection of the wireless communication device; and
the wireless communication device, comprising:
a transceiver to receive the message containing information relating to one or more preferred VNs for the wireless roaming service connection; and
a processor coupled to the transceiver to determine a VN from the information relating to one or more preferred VNs for a wireless roaming service connection.

17. The system according to claim 16, wherein the one or more preferred VNs are based on a geographic location of the wireless communication device.

18. The system according to claim 17, wherein the message is received from the HN by the wireless communication device over a connection between the device and the HN.

19. The system according to claim 18, wherein the message received by the wireless communication device from the HN is based on an authentication protocol message.

20. The system according to claim 19, wherein the message received by the wireless communication device from the HN is based on an Extensible Authentication Protocol (EAP) message.

21. The system according to claim 16, wherein the processor of the wireless communication device further to present to a user of the device a list of the one or more VNs for the wireless roaming service connection, the list containing the one or more preferred VNs contained in the information received in the message.

22. The system according to claim 21, wherein the processor further to determine a selection of a VN made by the user of the wireless communication device from the list of the one or more VNs for the wireless roaming service connection, and
wherein the transceiver of the wireless communication device is responsive to the selection determined by the processor to make a wireless roaming service connection to the selected VN.

23. The system according to claim 22, wherein the wireless communication device comprises a notebook-type computer, a tablet-type computer device, a portable or a handheld communication-type device, a reader-type device, a cellular telephone, or a personal digital assistant.

24. A method, comprising:
receiving a message at a wireless communication device from a Home Network (HN) of the device, the message containing information relating to one or more preferred Visited Networks (VNs) for a wireless roaming service connection the one or more preferred VNs being preferred by a Home Network (HN) of the device; and
determining a Visited Network (VN) from the information relating to one or more preferred VNs for a wireless roaming service connection.

25. The method according to claim 24, wherein the one or more preferred VNs are preferred based on a geographic location of the device when message is received.

26. The method according to claim 24, wherein determining a VN comprises presenting to a user of the device a list of the one or more VNs for the wireless roaming service connection, the list containing the one or more preferred VNs contained in the information received in the message.

27. The method according to claim 26, wherein determining a VN further comprises determining a selection of a VN made by the user of the device from the list of the one or more VNs for the wireless roaming service connection, and
making a wireless roaming service connection to the selected VN.

28. The method according to claim 27, wherein receiving the message comprises receiving the message between the wireless communication device and the HN.

29. The method according to claim 28, wherein the message received from the HN is based on an Extensible Authentication Protocol (EAP) message.

30. The method according to claim 27, wherein the device comprises a notebook-type computer, a tablet-type computer device, a portable or a handheld communication-type device, a reader-type device, a cellular telephone, or a personal digital assistant.
